(19) United States
(12) Patent Application Publication
(10) Pub. No.: US 2023/0156592 A1
(43) Pub. Date: May 18, 2023

(54) COMMUNICATION APPARATUS, COMMUNICATION METHOD, AND STORAGE MEDIUM

(71) Applicant: CANON KABUSHIKI KAISHA, Tokyo (JP)

(72) Inventor: Takatoshi Hirose, Kanagawa (JP)

(21) Appl. No.: 18/054,498

(22) Filed: Nov. 10, 2022

(30) Foreign Application Priority Data
Nov. 16, 2021 (JP) 2021-186665

(51) Int. Cl. H04W 52/02; H04W 4/20

(52) U.S. Cl. CPC H04W 52/0206; H04W 4/20

(57) ABSTRACT

A communication apparatus configured to perform, in parallel, a function for participating in a first communication network to perform communication and a function for participating in a second communication network to perform communication determines whether to transition to a second state after receiving a first frame based on a time period from when the communication apparatus receives the first frame to when the communication apparatus receives a second frame, in a case where the communication apparatus operates while transitioning between a first state and the second state, the second state being a state in which power consumption is lower than in the first state, and in a case where the communication apparatus receives the second frame from a second other communication apparatus after receiving, in the first state, the first frame from the first other communication apparatus.

### BACKGROUND

### Field

The present disclosure relates to a communication apparatus for performing wireless communication.

### Description of the Related Art

In a wireless communication apparatus conforming to an Institute of Electrical and Electronics Engineers (IEEE) 802.11 standard or another Wireless Fidelity (Wi-Fi) standard, a communication apparatus in which two functions — a station (hereinbelow, also referred to as an STA) function and an access point (hereinbelow, also referred to as an AP) function — operate in parallel has been discussed. The communication apparatus can establish connection with an STA using the AP function while establishing connection with an AP using the STA function.

Similarly, a communication apparatus that has a plurality of STA functions and that can perform a first STA function and a second STA function in parallel has been discussed. For example, the communication apparatus can establish connection with an AP using the first STA function to communicate therewith, and can establish, in parallel, connection with a group owner (GO) using a client function conforming to Wi-Fi Direct using the second STA function.

The IEEE 802.11 standards provide a power saving function as a function of reducing a battery power consumption amount of the STA. Japanese Patent Application Laid-open No. 2007-19607 and Japanese Patent Application Laid-open No. 2009-206762 discuss a technique for communication with reduced power consumption implemented through controlling of a power save mode.

The above-described communication apparatus having the plurality of STA functions can operate while transitioning between a first state and a second state with a power consumption lower than that of the first state in conformity with the IEEE 802.11 standards. However, in the case of the communication apparatus having the plurality of STA functions including the first STA function and the second STA function, for example, the following issue can arise. Specifically, there may be a case where, after receiving a frame from a first AP, which is a connection destination of the first STA function, and transitioning to the second state, the communication apparatus receives a frame from a second AP in the course of transitioning to the first state to receive the frame from the second AP, which is a connection destination of the second STA function. In the state described above, there is a possibility that the communication apparatus having the plurality of STA functions including the first STA function and the second STA function cannot receive the frame from the second AP, and this can cause a packet loss.

### SUMMARY

Various embodiments of the present disclosure are directed to a communication apparatus capable of receiving a frame transmitted from another communication apparatus more reliably.

According to one embodiment of the present disclosure, a communication apparatus configured to perform, in parallel, a function for participating in a first communication network to perform communication and a function for participating in a second communication network to perform communication includes a reception unit configured to receive a first frame periodically transmitted from a first other communication apparatus that forms the first communication network, and a second frame periodically transmitted from a second other communication apparatus that forms the second communication network, and a control unit configured to control the communication apparatus to determine whether to transition to a second state after receiving the first frame based on a time period from when the communication apparatus receives the first frame to when the communication apparatus receives the second frame, in a case where the communication apparatus operates while transitioning between a first state and the second state, the second state being a state in which power consumption is lower than in the first state, and in a case where the communication apparatus receives the second frame from the second other communication apparatus after receiving, in the first state, the first frame transmitted from the first other communication apparatus.

Further features of the present disclosure will become apparent from the following description of example embodiments with reference to the attached drawings.

### BRIEF DESCRIPTION OF THE DRAWINGS

FIG. 1 is a diagram illustrating a network configuration according to an example embodiment.

FIG. 2 is a block diagram illustrating a hardware configuration of a communication apparatus (station (STA)).

FIG. 3 is a flowchart illustrating processing of the STA according to a first example embodiment.

FIG. 4 is a flowchart illustrating processing of an STA according to a second example embodiment.

FIGS. 5A, 5B, 5C, and 5D are diagrams illustrating state transitions of an STA when access points (APs) transmit Beacon frames.

FIG. 6 is a diagram illustrating an example of information which an STA according to the second example embodiment notifies a user of.

### DESCRIPTION OF THE EMBODIMENTS

Hereinbelow, example embodiments of the present disclosure will be described in detail with reference to the attached drawings. However, it is to be noted that the example embodiments described below are merely examples, and apparatuses, systems, methods, programs, media, and the like in various forms configured to implement the functions described below are included within the range of the claims.

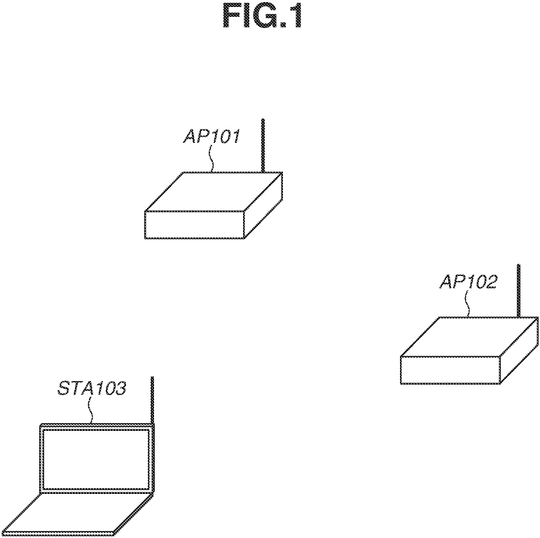

FIG. 1 illustrates a network configuration of a communication system according to an example embodiment of the present disclosure. In FIG. 1, communication apparatuses 101 and 102 are access points (APs) constituting a communication network, and a communication apparatus 103 is a station (STA) participating in the communication network consisting of the APs and performing communication. Hereinbelow, the communication apparatuses 101 and 102 are also referred to as APs 101 and 102, and the communication apparatus 103 is also referred to as an STA 103. The STA 103 may be a personal computer (hereinbelow, referred to as a PC). In the STA 103, two STA functions are operable, and the STA 103 can establish connection with two APs to communicate therewith.

Further, the STA 103 can establish connection with an AP to communicate therewith using a first STA function, and can establish connection, in parallel, with a group owner (GO) to communicate therewith using a second STA function based on a client function conforming to Wireless Fidelity (Wi-Fi) Direct.

The communication apparatuses 101, 102, and 103 can perform a power saving function conforming to a series of Institute of Electrical and Electronics Engineers (IEEE) 802.11 standards. The STA 103 operating in a power save mode regularly transitions between an Awake state and a Doze state, which is a low power consumption state lower in power consumption than the Awake state. In the present example embodiment, the Awake state is a state in which power is supplied to circuits of the STA 103 and the STA 103 can transmit and receive frames, and the Doze state is a state in which the STA 103 cannot transmit or receive frames.

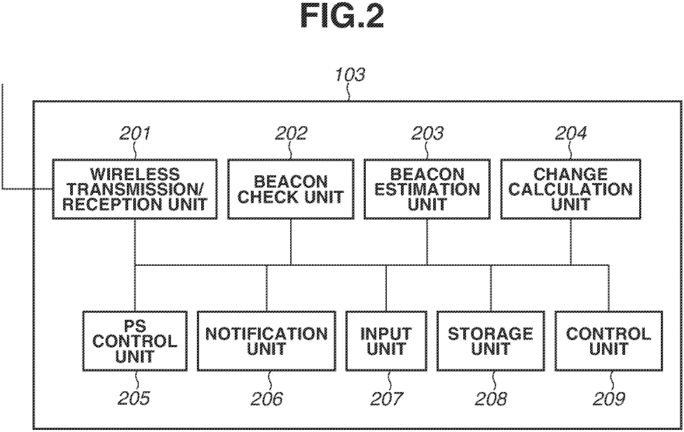

FIG. 2 is a block diagram illustrating a hardware configuration of the STA 103. The STA 103 includes a wireless transmission/reception unit 201, a Beacon check unit 202, a Beacon estimation unit 203, a change calculation unit 204, a power save (PS) control unit 205, a notification unit 206, an input unit 207, a storage unit 208, and a control unit 209.

The wireless transmission/reception unit 201 transmits and receives wireless signals such as a Beacon frame. Further, when the STA 103 operates in the power save mode, the wireless transmission/reception unit 201 turns on and off power supply in a reception circuit.

The Beacon check unit 202 checks the contents of a Beacon signal received by the wireless transmission/reception unit 201. The Beacon frame is a frame for periodically providing a notification about network information. The Beacon frame includes information for communication using a frequency channel that transmits the Beacon frame, such as a Beacon frame transmission interval and an operable frequency channel, and information for an STA that establishes connection with an AP to be in time synchronization therewith.

In the present example embodiment, the Beacon check unit 202 checks information relating to a Delivery Traffic Indication Message (DTIM) interval included in the Beacon.

The Beacon estimation unit 203 estimates a timing of receiving a Beacon based on the contents checked by the Beacon check unit 202. Further, the Beacon estimation unit 203 performs estimation, for Beacon signals received from the same AP, each time a Beacon is received. Alternatively, the Beacon estimation unit 203 may perform the estimation only the first time. Further, depending on a check result by the Beacon check unit 202, the Beacon estimation unit 203 may perform the estimation only in a case where a parameter related to power saving changes.

The change calculation unit 204 calculates an on/off pattern of the reception circuit different depending on the APs with which the STA 103 has established connection and the number of connections.

The PS control unit 205 transmits, to the wireless transmission/reception unit 201, an instruction to transition to the power save mode in a case where the STA 103 operates in the power save mode based on information from each block.

The notification unit 206 provides a notification to a user. In the present example embodiment, the notification unit 206 provides the notification by displaying characters or images on a liquid crystal panel, but a method of notifying the user by a color of light or a lighting pattern using light-emitting diodes (LEDs), or a sound using a buzzer may also be employed. Further, a method of notifying the user by a display on a monitor screen, an audio output through a speaker, or a vibrational output may also be employed.

The input unit 207 accepts various operations from the user. The notification unit 206 provides various outputs to the user via the monitor screen or the speaker. In the present example embodiment, the notification unit 206 also serves as an interface used by the PS control unit 205 to make an inquiry to the user.

In the present example embodiment, since the STA 103 is a PC, the input unit 207 is a mouse, but any input unit can be used as long as the user can make an input. In addition, the input unit 207 and the notification unit 206 may be configured as one module such as a touch panel. Further, the input unit 207 and the notification unit 206 may each be built in the STA 103, or separately configured.

The storage unit 208 includes a memory such as a read-only memory (ROM) or a random access memory (RAM), and stores programs for executing various kinds of processing to be described below and various kinds of information. A storage medium such as a flexible disk, a hard disk, an optical disk, a magneto-optical disk, a compact disk (CD)-ROM, CD-recordable (R), a magnetic tape, a non-volatile memory card, or a digital versatile disk (DVD) may be used as the storage unit 208 in addition to the memory such as the ROM or the RAM. Further, the storage unit 208 may include a plurality of memories.

The control unit 209 includes, for example, a processor such as a Central Processing Unit (CPU) or a Micro Processing Unit (MPU), an Application Specific Integrated Circuits (ASIC), a Digital Signal Processor (DSP), and a Field Programmable Gate Array (FPGA).

The control unit 209 entirely controls the AP 101, the AP 102, and the STA 103 by executing the programs stored in the storage unit 208. In addition, the control unit 209 may entirely control the AP 101, the AP 102, and the STA 103 by executing the programs stored in the storage unit 208 and the Operating System (OS) in corporation.

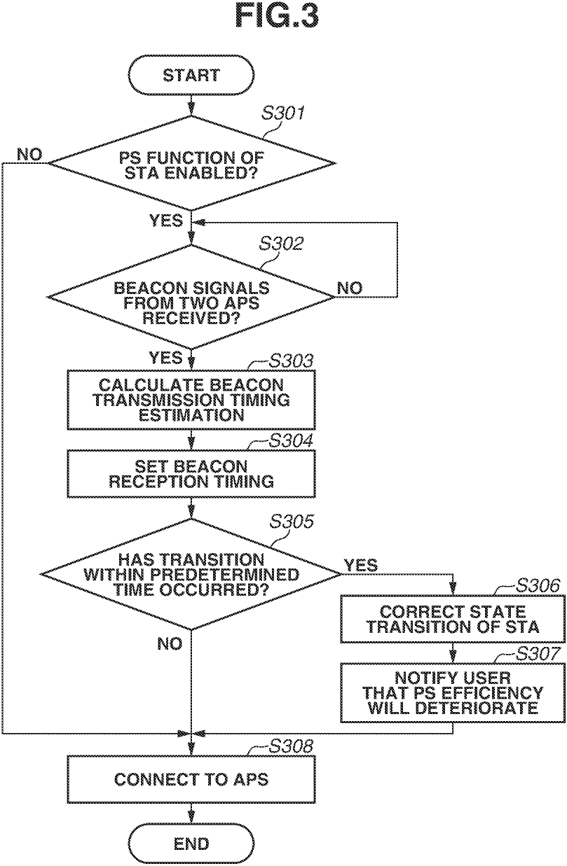

FIG. 3 is a flowchart illustrating a processing procedure performed by the control unit 209 executing the program stored in the storage unit 208 of the STA 103. The flowchart illustrates a state transition processing procedure of the STA 103 when the STA 103 receives Beacon frames from the plurality of APs 101 and 102.

The flowchart starts when the power of the STA 103 is turned on, a wireless LAN function of the STA 103 is turned on, or a Service Set Identifier (SSID) of a connection destination AP is selected by the user operating the input unit 207. In a first example embodiment, SSIDs respectively for two APs 101 and 102 are input.

In step S301, the control unit 209 checks whether the power saving (hereinbelow, also referred to as a PS) function of the STA 103 is enabled. In step S301, in a case where the control unit 209 determines that the PS function is disabled (NO in step S301), the processing proceeds to step S308. In step S308, the control unit 209 starts a connection sequence without performing PS control. Then, the control unit 209 ends the flowchart.

In step S301, in a case where the control unit 209 of the STA 103 determines that the PS function is enabled (YES in step S301), the processing proceeds to step S302. In step S302, the control unit 209 determines whether the STA 103 has received Beacon signals transmitted from the two APs 101 and 102 the SSIDs of which have been input by the user. In step S302, in a case where the STA 103 cannot receive the Beacon signals after waiting for a predetermined time period (NO in step S302), the processing may be canceled, and the processing may be restarted from the user input.

In step S302, in a case where the control unit 209 determines that the Beacon signals from the APs selected by the user are received (YES in step S302), the processing proceeds to step S303. In step S303, the Beacon estimation unit 203 calculates a Beacon transmission timing estimation. As a calculation method of the Beacon transmission timing estimation, first, the Beacon check unit 202 obtains an SSID, a MAC address, a time stamp of the Beacon signal reception time, and a Beacon cycle, or a DTIM interval for each of the APs, and stores them in the storage unit 208. Then, the Beacon estimation unit 203 performs calculation by obtaining the parameters stored in the storage unit 208.

After the transmission timing estimation of the Beacon signals is completed, a state transition for receiving a Beacon frame from the AP 101 and a state transition for receiving a Beacon frame from the AP 102 are combined. In step S304, the PS control unit 205 sets a Beacon reception timing of the STA 103 so as to match a result of combining, and issues an instruction to the wireless transmission/reception unit 201.

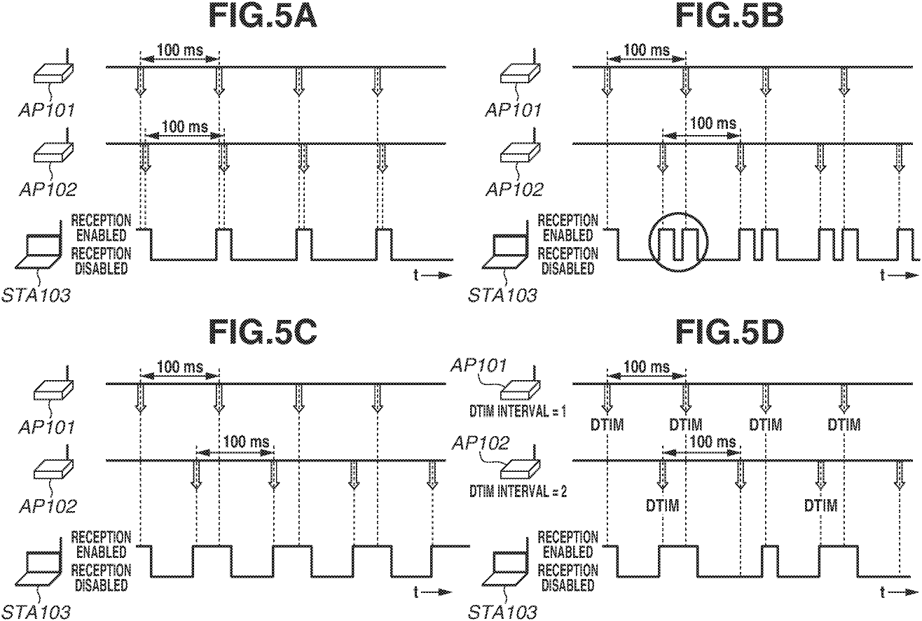

FIGS. 5A to 5D illustrate timings at which Beacon frames are received from the AP 101 and the AP 102, and the state transitions of the STA 103. As illustrated in FIGS. 5A to 5D, the STA 103 regularly transitions between a “reception enabled” state and a “reception disabled” state. In the present example embodiment, the “reception enabled” state is the Awake state, and the STA 103 transitions to the Awake state to receive a Beacon frame transmitted from the AP 101 or the AP 102. The “reception disabled” state is the Doze state, which is a low power consumption state lower in power consumption than the Awake state. In a case where the PS function of the STA 103 is enabled, the STA 103 operates while transitioning regularly between the Awake state and the Doze state.

FIG. 5A illustrates an example in which a Beacon transmission timing of the AP 101 and a Beacon transmission timing of the AP 102 are relatively close. FIG. 5A illustrates an example in which the STA 103 can receive a Beacon frame from the AP 102 when the STA 103 is in the Awake state to receive a Beacon frame from the AP 101. In FIG. 5A, since the STA 103 is in the Awake state to receive a frame from the AP 101 and the STA 103 can receive a Beacon frame from the AP 102, a correction of the state transition of the STA 103 is not required.

In step S305, the control unit 209 refers to the state transition of the STA 103 for receiving a Beacon frame from the AP 101 and the state transition of the STA 103 for receiving a Beacon frame from the AP 102. Specifically, the PS control unit 205 determines whether a transition from the Awake state to the Doze state or a transition from the Doze state to the Awake state occurs within a predetermined time in the state transition of the STA 103 for the AP 101 and the state transition of the STA 103 for the AP 102. More specifically, in the Awake state, the PS control unit 205 measures a time from when a Beacon frame is received from the AP 101 to when a Beacon frame is received from the AP 102, and determines whether the measured time is larger than a predetermined value. In this case, in FIG. 5A, the PS control unit 205 determines that no transition has occurred within the predetermined time (NO in step S305), the processing proceeds to step S308. In step S308, the AP 101 and the STA 103 establish connection, and further the AP 102 and the STA 103 establish connection. Then, the control unit 209 ends the flowchart.

FIG. 5B illustrates an example in which the interval between the Beacon transmission timings of the AP 101 and the AP 102 are relatively far from each other. In this case, in step S305, the PS control unit 205 determines that the state transition has occurred within the predetermined time at a position indicated by a circle in FIG. 5B (YES in step S305), and the processing proceeds to step S306. In step S306, the state transition of the STA 103 is corrected as illustrated in FIG. 5C. More specifically, in a case where the time from when the Beacon frame is received from the AP 101 to when the Beacon frame is received from the AP 102 is the predetermined value or less, a correction is performed to prevent frequent transitions from occurring between the Awake state and the Doze state. In the present example embodiment, even at a timing to transition to the Doze state, the PS control unit 205 controls the state of the STA 103 to maintain the Awake state.

If the PS control unit 205 corrects the state transition as illustrated in FIG. 5C and the STA 103 establishes connection with each of the AP 101 and the AP 102, since the Awake state frequently occurs to deteriorate the efficiency of PS. Thus, in step S307, the STA 103 notifies the user that the efficiency of the PS will deteriorate. After the notification to the user in step S307, in step S308, the AP 101 and the STA 103 are connected, and further the AP 102 and the STA 103 are connected. The notification timing is before the connection to the AP 101 is established in the present example embodiment, but the STA 103 may provide the notification before the connection to the second AP is established, or after the wireless connection to the second AP is established.

In addition, in the present example embodiment, the case where the DTIM interval of the second AP is “1” is described with reference to FIG. 5C. Timing in a case where the DTIM interval of the AP 102 is “2” is illustrated in FIG. 5D. Further, a reception timing correction may be performed only on a correction-required portion without performing the reception timing correction each time the STA 103 receives a Beacon frame.

According to the present example embodiment, in the case where an STA including a plurality of STA functions operates in the PS mode and establishes connection with a plurality of APs, it is possible to restrain a state where a Beacon frame cannot be received from occurring, by prohibiting a transition to the Doze state depending on the situation. Further, it is possible to improve usability since the user is notified that the efficiency of the PS will deteriorate by the Awake state continuing.

In the first example embodiment, the case where the user is notified that the power saving efficiency will deteriorate depending on the situation when the Awake state is continued is described as an example. In a second example embodiment, in a case where the user is notified that the power saving efficiency will deteriorate when the Awake state is continued, an example in which an inquiry to inquire whether to establish connections with a plurality of APs even though the power saving efficiency deteriorates is described.

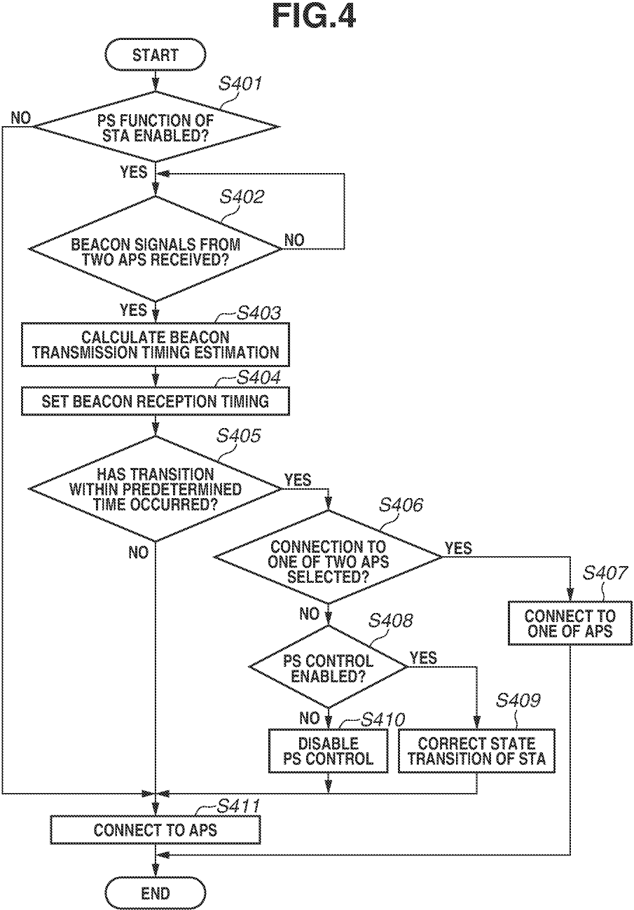

FIG. 4 is a flowchart illustrating a procedure of processing performed by the control unit 209 executing the program stored in the storage unit 208 of the STA 103. The flowchart illustrates a state transition processing procedure of the STA 103 when the STA 103 receives Beacon frames from a plurality of APs.

Processing performed in steps S401 to S405 is similar to that in steps S301 to S305 in FIG. 3. Thus, descriptions thereof are omitted.

In step S406, the STA 103 inquires of a user whether to establish connection with the two APs the SSIDs of which have been input by the user, or either of the APs. The inquiry in step S406 is, for example, an inquiry whether to prioritize the power saving because the power saving efficiency will deteriorate if the STA 103 establishes connection with two APs. At this time, in step S406, the connection itself may be canceled in response to the inquiry.

In step S406, in a case where the user selects connection to one of the AP 101 and the AP 102 (YES in step S406), i.e., the user prioritizes the power save mode, the processing proceeds to step S407. In step S407, the STA 103 establishes connection only to the AP 102. At this time, the STA 103 may inquire only about the number of APs to which the user desires to establish connection, and may establish connection with an AP(s) with a high radio field intensity.

In step S406, in a case where the user desires to connect to two APs 101 and 102 (NO in step S406), i.e., the user does not prioritize the power save mode, the processing proceeds to step S408. In step S408, the STA 103 inquires of the user whether to maintain the PS control in an enabled state or to switch the PS control to a disabled state. In step S408, in a case where the user selects maintaining the PS control in the enabled state (YES in step S408), the processing proceeds to step S409. In step S409, the PS control unit 205 corrects the state transition of the STA 103 to receive Beacon frames from the two APs 101 and 102 and connects to the two APs 101 and 102, and then ends the flowchart.

In step S408, in a case where the user selects switching the PS control to the disabled state (NO in step S408), the processing proceeds to step S410. In step S410, the STA 103 wirelessly connects to the two APs 101 and 102 after disabling the PS control.

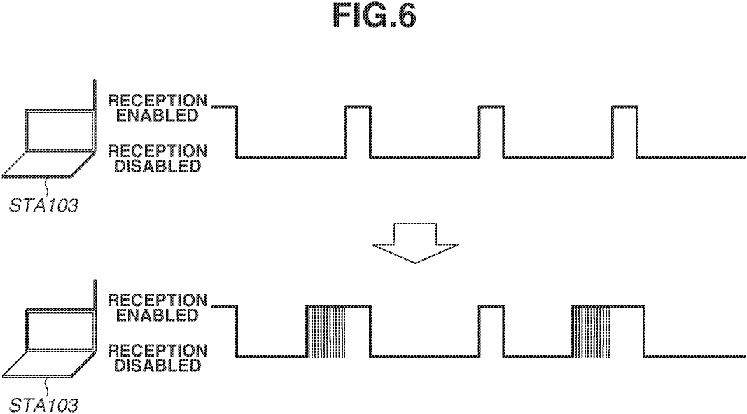

In step S406 or step S408, the notification unit 206 may notify the user of the Beacon reception timings as illustrated in FIG. 6. FIG. 6 illustrates examples of a PS state in the case of connecting with the AP 101 and in the case of connecting with both the AP 101 and the AP 102, and the change calculation unit 204 calculates PS states and difference information.

Further, in step S408, the PS control may be executed depending on whether the STA 103 is driven by a battery or by a power source, without inquiring about the PS control. In this case, in the case of battery, the PS control is enabled, and in the case of the power source, the PS control is disabled. Further, in the present example embodiment, the case where the STA 103 connects to the two APs 101 and 102 has been described above as an example, but the present example embodiment is not limited thereto, and the STA 103 can connect to more than two APs.

According to the present example embodiment, it is possible to restrain the STA from failing to receive the Beacon frame by preventing the STA from transitioning to the Doze state depending on the situation in the case where the STA including the plurality of STA functions operates in the PS mode and establishes connection with the plurality of APs. Further, it is possible to improve the usability since the user is notified that the PS efficiency will deteriorate by the Awake state continuing, and since the user can select not establishing connection with the plurality of APs, for example, if the user does not want the PS efficiency to deteriorate.

The STA 103 according to the present example embodiment may be a printer including a printing unit. In a case where the STA 103 operates as the printer, for example, the printer can print data obtained from a partner apparatus through communication therewith.

Further, the STA 103 according to the present example embodiment may be a camera including an imaging unit. In a case where the STA 103 operates as the camera, for example, the camera can send captured data to a partner apparatus through communication therewith.

In addition, a storage medium storing a program code of software that implements the above-described functions may be supplied to a system or an apparatus, and a computer (CPU or MPU) may read and execute the program code stored in the storage medium. In this case, the program code itself that is read from the storage medium implements the functions of each of the example embodiment described above, and the storage medium storing the program code is included in the above-described apparatuses.

As the storage medium for supplying the program code, for example, a flexible disk, a hard disk, an optical disk, a magneto-optical disk, a CD-ROM, a CD-R, a magnetic tape, a nonvolatile memory card, a ROM, and a DVD can be used.

Further, the above-described functions may be implemented not only by the computer executing the read program code, but also by an Operating System (OS) that is operating on the computer executing a part of or all of the actual processing based on instructions provided by the program code.

Further, the program code read from the storage medium may be written into a memory provided in a function expansion board inserted in the computer or a function expansion unit connected to the computer.

Then, a CPU provided in the function expansion board or the function expansion unit may execute a part of or all of the actual processing based on the instructions provided by the program code to implement the above-described functions.

Various embodiments of the present disclosure can be realized by processing of supplying a program for implementing one or more functions of the above-described example embodiments to a system or an apparatus via a network or a storage medium and one or more processors in a computer of the system or the apparatus reading and executing the program. Further, some embodiments of the present disclosure can also be realized by a circuit (e.g., ASIC) that can implement one or more functions.

According to various embodiments of the present disclosure, it is possible to more securely receive frames transmitted from another communication apparatus. Other Embodiments

Various embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While example embodiments have been described, it is to be understood that the invention is not limited to the disclosed example embodiments. The scope of the following claims is to be accorded the broadest interpretation so as to encompass all such modifications and equivalent structures and functions.

This application claims the benefit of Japanese Patent Application No. 2021-186665, filed Nov. 16, 2021, which is hereby incorporated by reference herein in its entirety.

What is claimed is:

1. A communication apparatus configured to perform, in parallel, a function for participating in a first communication network to perform communication and a function for participating in a second communication network to perform communication, the communication apparatus comprising:
a reception unit configured to receive a first frame periodically transmitted from a first other communication apparatus that forms the first communication network, and a second frame periodically transmitted from a second other communication apparatus that forms the second communication network; and
a control unit configured to control the communication apparatus to determine whether to transition to a second state after receiving the first frame based on a time period from when the communication apparatus receives the first frame to when the communication apparatus receives the second frame, in a case where the communication apparatus operates while transitioning between a first state and the second state, the second state being a state in which power consumption is lower than in the first state, and in a case where the communication apparatus receives the second frame from the second other communication apparatus after receiving, in the first state, the first frame transmitted from the first other communication apparatus.

2. The communication apparatus according to claim 1, further comprising a notification unit configured to provide a user with a notification that power saving efficiency will deteriorate if the control unit continues the first state.

3. The communication apparatus according to claim 2, wherein the notification unit provides the notification when the communication apparatus establishes connection with the second other communication apparatus.

4. The communication apparatus according to claim 2, wherein the notification unit provides the user with the notification of information about a power saving state when the communication apparatus establishes connection with the first other communication apparatus and the second other communication apparatus.

5. The communication apparatus according to claim 2, further comprising a reception unit configured to receive an input from the user,
wherein the notification unit prompts the user to select, using the reception unit, whether to establish connection with both the first other communication apparatus and the second other communication apparatus, or either the first other communication apparatus or the second other communication apparatus.

6. The communication apparatus according to claim 1, wherein the first frame and the second frame are Beacon frames conforming to Institute of Electrical and Electronics Engineers (IEEE) 802.11 standards.

7. The communication apparatus according to claim 1, wherein an interval between the first frames and an interval between the second frames are Delivery Traffic Indication Message (DTIM) intervals conforming to IEEE 802.11 standards.

8. The communication apparatus according to claim 1, wherein the communication apparatus operates in a power save mode conforming to IEEE 802.11 standards.

9. The communication apparatus according to claim 1, wherein the first other communication apparatus and the second other communication apparatus operate as access points (APs) conforming to IEEE 802.11 standards.

10. A communication method for a communication apparatus configured to perform, in parallel, a function for participating in a first communication network to perform communication, and a function for participating in a second communication network to perform communication, the communication method comprising:
receiving a first frame periodically transmitted from a first other communication apparatus that forms the first communication network, and a second frame periodically transmitted from a second other communication apparatus that forms the second communication network;
controlling the communication apparatus to determine whether to transition to a second state after receiving the first frame based on a time period from when the communication apparatus receives the first frame to when the communication apparatus receives the second frame, in a case where the communication apparatus operates while transitioning between a first state and the second state, the second state being a state in which power consumption is lower than in the first state, and in a case where the communication apparatus receives the second frame from the second other communication apparatus after receiving, in the first state, the first frame transmitted from the first other communication apparatus.

11. A non-transitory computer-readable storage medium storing instructions that, when executed by a computer, cause the computer to perform a communication method, the communication method comprising:
receiving a first frame periodically transmitted from a first other communication apparatus that forms the first communication network, and a second frame periodically transmitted from a second other communication apparatus that forms the second communication network;
controlling the communication apparatus to determine whether to transition to a second state after receiving the first frame based on a time period from when the communication apparatus receives the first frame to when the communication apparatus receives the second frame, in a case where the communication apparatus operates while transitioning between a first state and the second state, the second state being a state in which power consumption is lower than in the first state, and in a case where the communication apparatus receives the second frame from the second other communication apparatus after receiving, in the first state, the first frame transmitted from the first other communication apparatus.
